(19) United States
(12) Patent Application Publication
(10) Pub. No.: US 2025/0207719 A1
(43) Pub. Date: Jun. 26, 2025

(54) Mobile Electronic Device Holder

(71) Applicant: Huanwei CHEN, Guangdong (CN)

(72) Inventor: Huanwei CHEN, Guangdong (CN)

(21) Appl. No.: 19/076,416

(22) Filed: Mar. 11, 2025

(51) Int. Cl. F16M 11/12; F16M 11/04

(52) U.S. Cl. CPC F16M 11/12; F16M 11/041; F16M 2200/02; F16M 2200/063

(57) ABSTRACT

The present disclosure provides a mobile electronic device holder, comprising a holder body, which is provided with an angle adjustment device; a connector can be pivoted to achieve multi-directional adjustment, a mounting groove is configured to stably install a clamping mechanism; an anti-loosening mechanism between the connecting end of the connecting shaft and the connector achieves an anti-loosening effect with a clamping piece, a textured anti-loosening washer and a conical convex surface in cooperation; a locking mechanism enables the connecting end of the connecting shaft and the connector and other components to achieve self-locking; the other end of the connecting shaft is nested with the pivot groove through a universal ball to achieve multi-angle rotation.

### TECHNICAL FIELD

The present disclosure relates to the technical field of electronic device holders, particularly to a mobile electronic device holder.

### BACKGROUND

A mobile electronic device holder is an auxiliary tool used to fix, support, or adjust the position of electronic devices (such as mobile phones, tablets, smart watches, cameras, etc.), aiming to enhance convenience, safety, or optimize viewing and operation experience.

For example, the existing U.S. Pat. No. 9,573,686 discloses an “Adjustable clamping mount for cell phones, tablets and other mobile devices.” This patent achieves angle adjustment of the holder through hinge components, but the angle adjustment mechanism of this patent has some drawbacks. For instance, its angle adjustment device has low friction, making it difficult to support heavier electronic devices for extended periods. As a result, after prolonged use, the electronic device may become loose and exhibit a “drooping” phenomenon, severely affecting the user experience.

Therefore, there is a need to propose a new type of holder with higher support capacity, making it easier to support heavier mobile electronic devices.

### SUMMARY

The present disclosure provides a mobile electronic device holder to solve the problems raised in the background technology.

To achieve the above-mentioned object of the disclosure, the present disclosure adopts the following technical solutions:

A mobile electronic device holder includes a holder body, wherein the holder body is equipped with an angle adjustment device, the angle adjustment device comprises a connector installed on the holder body, and the connector is provided with a mounting groove; and the adjustment device further comprises a connecting shaft, one end of which is located in the mounting groove and is configured as a connecting end, and an anti-loosening mechanism is arranged between the connecting end and the connector; and the anti-loosening mechanism comprises clamping pieces clamped on two radial sides of the connecting end; and a conical anti-loosening washer is arranged between the clamping pieces and an inner wall of the mounting groove, and a surface of the anti-loosening washer is provided with anti-slip patterns; and the inner wall of the mounting groove is provided with a conical convex surface, and the anti-loosening washer is sleeved outside the conical convex surface and forms a taper fit with the conical convex surface.

The present disclosure further provides a mobile electronic device holder, including a holder body, wherein the holder body is provided with an angle adjustment device, the angle adjustment device comprises a U-shaped part installed on the holder body, and an interior of the U-shaped part is configured as a mounting groove; and the adjustment device further comprises a connecting shaft, one end of which is located in the mounting groove and is configured as a connecting end, and an anti-loosening mechanism is arranged between the connecting end and a connector; and the anti-loosening mechanism comprise clamping pieces clamped on two radial sides of the connecting end; and a conical anti-loosening washer is arranged between the clamping pieces and an inner wall of the mounting groove, and a surface of the anti-loosening washer is provided with anti-slip patterns; and the inner wall of the mounting groove is provided with a conical convex surface, and the anti-loosening washer is sleeved outside the conical convex surface and forms a taper fit with the conical convex surface; and the U shaped part is equipped with a locking mechanism, which is configured to lock the adjustment device and the anti-loosening mechanism.

### BRIEF DESCRIPTION OF DRAWINGS

The drawings, which constitute a part of this application, are provided to further explain the present disclosure. The illustrative embodiments and the descriptions thereof are used to explain the present disclosure and do not constitute an improper limitation of the present disclosure. In the drawings:

FIG. 1 is a schematic diagram of the product of the present disclosure;

FIG. 2 is a structural schematic diagram of the present disclosure;

FIG. 3 is a structural schematic diagram of the angle adjustment device in FIG. 2;

FIG. 4 is a structural schematic diagram of the anti-loosening mechanism in FIG. 2;

FIG. 5 is a schematic diagram of the structure of the clamping piece in FIG. 4;

FIG. 6 is a schematic diagram of the structure of the locking mechanism in FIG. 2;

FIG. 7 is a schematic diagram of the structure of the anti-loosening washer in FIG. 4;

FIG. 8 is a schematic diagram of the structure of the clamping mechanism in FIG. 1;

FIG. 9 is a schematic diagram of the structure where conical convex surfaces are set on both the support plate and the clamping piece, and then the corresponding anti-loosening washer is arranged in another embodiment of the present disclosure;

FIG. 10 is a schematic diagram of the structure of the U-shaped part in another embodiment of the present disclosure.

Reference signs: Holder body (1); Angle adjustment device (100); Connector (101); Support plate (102); Mounting groove (103); Connecting shaft (104); Connecting end (105); Clamping mechanism (106); Universal ball (107); Pivot groove (108); Anti-loosening mechanism (200); Clamping piece (201); Arc-shaped portion (202); Anti-loosening washer (203); Anti-slip pattern (204); Conica convex surface (205); Locking mechanism (300); First locking member (301); Second locking member (302); Extending end (303); U-shaped part (401); Rotating handle (402); Axis (a).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

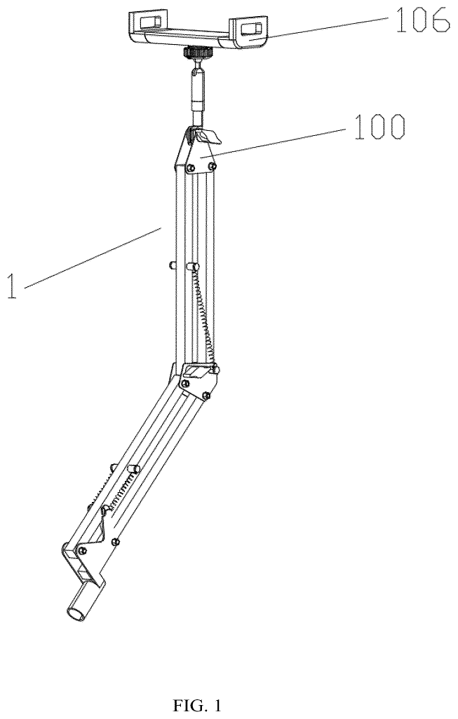

As shown in FIGS. 1 to 10,

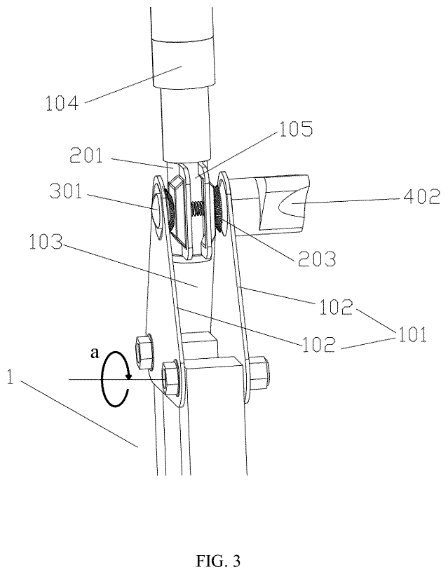

As shown in FIGS. 1 and 3, a mobile electronic device holder includes a holder body 1. The holder body 1 is provided with an angle adjustment device 100. The angle adjustment device 100 includes a connector 101 (see FIG. 3) installed on the holder body 1 by bolts. The connector 101 can pivot relative to the holder body 1 around an axis a perpendicular to the mounting surface of the holder body 1, thereby realizing the multi-directional adjustment function of the angle adjustment device 100.

Specifically, as shown in FIG. 3, the connector 101 consists of two parallel support plates 102. Among them, the support plates 102 are triangular. Both of the two support plates 102 are installed on the holder body 1 and arranged at intervals. The interval formed by the two support plates 102 is configured as a mounting groove 103. The mounting groove 103 can be used to install the clamping mechanism 106 of the electronic device (see FIG. 1), so that the mobile electronic device can be stably placed on the holder, ensuring that the device will not easily shake or shift during use. In other embodiments, the support plates 102 can also be in other shapes such as rectangles and circles. Different shapes of the support plates 102 may have different impacts on the spatial structure of the mounting groove 103, the pivoting performance of the connector 101, and the overall stability of the angle adjustment device 100. Reasonable choices can be made according to the actual usage requirements and product design.

In this embodiment, the support plates 102, as a component of the connector 101, are installed on the holder body 1. They not only participate in forming the structure of the pivotable connector but are also spaced apart to form the mounting groove 103 for mounting other components. At the same time, they ensure the stability of the connection between the angle adjustment device 100 and the holder body 1. After fixing other components to the holder body 1, the angle adjustment device 100 can stably support the related parts within the mounting grooves 103, forming a structurally stable and tightly integrated whole for the entire angle adjustment device 100. This ensures the relative positional relationships between the components, thereby guaranteeing the normal operation of the device.

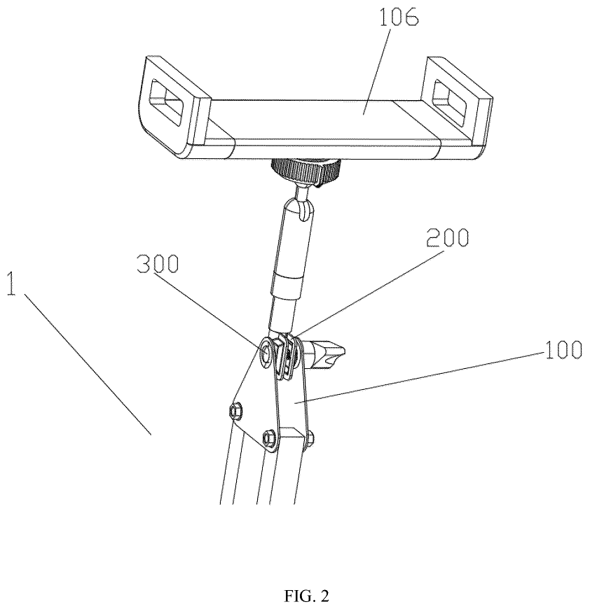

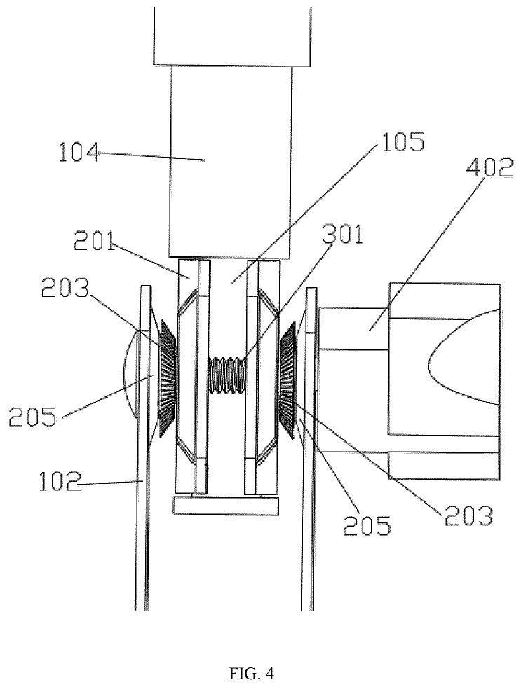

As shown in FIGS. 3 and 4, in this embodiment, the angle adjustment device 100 also includes a connecting shaft 104. One end of the connecting shaft 104 serves as a connecting end 105 located within the mounting groove 103. An anti-loosening mechanism 200 (see FIG. 2) is arranged between the connecting end 105 and the connector 101. The anti-loosening mechanism 200 includes clamping pieces 201 that are clamped the radial sides of the connecting end 105. The clamping pieces 201 are provided with arc-shaped portions 202, and the arc-shaped portions 202 on both clamping pieces 201 cooperate to form a gap that matches the shape and size of the connecting end 105, so that the connecting end 105 is clamped between the arc-shaped portions 202 of the two clamping pieces 201. When the anti-loosening mechanism 200 is not locked, the connecting end 105 is rotatable between the arc-shaped portions 202 of the two clamping pieces 201. Through the angle pre-adjustment function, users can quickly determine the approximate angle of the device, reducing the number of attempts and adjustment time during the adjustment process, thereby significantly improving the efficiency of the entire angle adjustment.

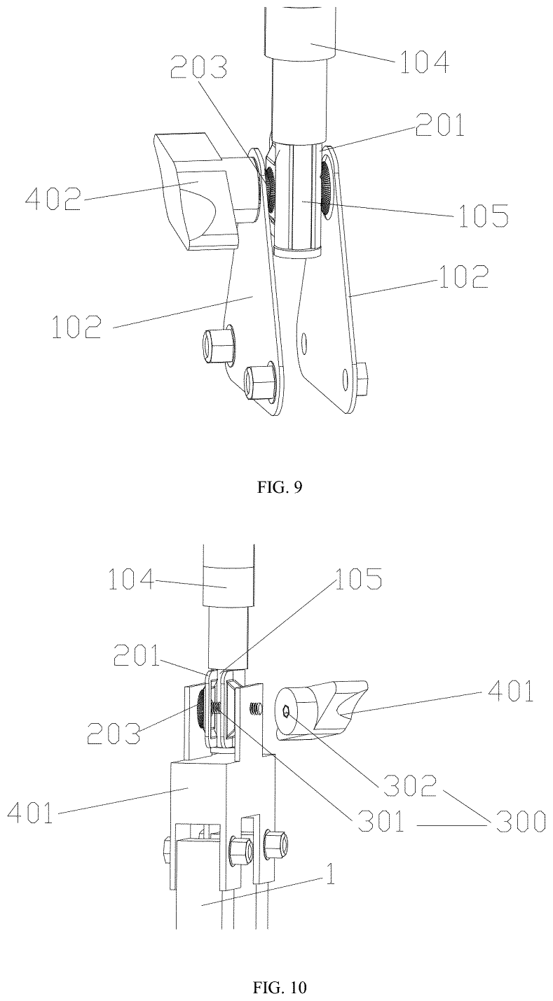

As shown in FIG. 4, in this embodiment, a conical anti-loosening washer 203 is arranged between the clamping piece 201 and the inner wall of the mounting groove 103 (see FIG. 3). At the connection between the anti-loosening washer 203 and the mounting groove 103, a conical convex surface 205 is provided on the inner wall of the mounting groove 103. The anti-loosening washer 203 is sleeved outside the conical convex surface 205 and forms a taper fit with the conical convex surface 205. During the use of the angle adjustment device 100, the connecting end 105 of the connecting shaft 104 and the connector 101 are subject to vibrations, impacts, and forces and moments generated by the operation of the device, which can easily cause loosening. The anti-loosening washer 203 effectively prevents axial relative movement between the connecting end 105 and the connector 101 through tight contact with the clamping piece 201, taper fit with the conical convex surface 205, and close fit with the inner wall of the mounting groove 103, thereby effectively preventing connection loosening and ensuring the reliability of the connection. In other embodiments, the conical convex surface 205 is not limited to being set on the support plate 102, but can also be set on the clamping piece 201, or both the support plate 102 and the clamping piece 201 can be provided with conical convex surfaces 205, and then corresponding anti-loosening washers 203 are set (see FIG. 9). The anti-loosening washer 203 can also be replaced with other anti-loosening components such as spring washers and wedge lock pieces.

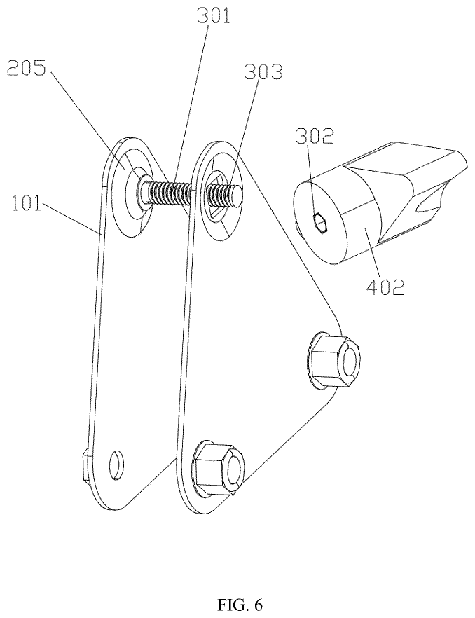

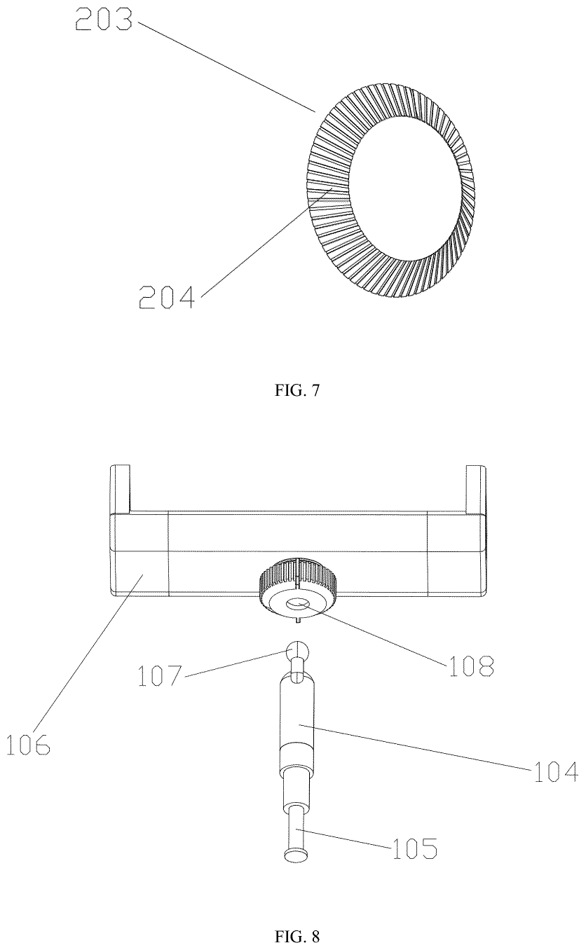

Specifically, referring to FIG. 7, the surface of the anti-loosening washer 203 is provided with anti-slip patterns 204. The anti-slip patterns 204 can enhance the friction between the anti-loosening washer 203 and the adjacent components to prevent relative rotation and improve the connection stability. In other embodiments, the anti-slip patterns 204 of the anti-loosening washer 203 are not limited to the shapes shown in the existing drawings. The anti-slip patterns 204 can also be in the forms of wavy lines, diagonal lines, bumps, etc.

Refer to FIG. 4. In this embodiment, the anti-loosening washer 203 is made of a hard elastic material, which has good toughness and energy dissipation characteristics. During the use of the angle adjustment device 100 (refer to FIG. 2), the anti-loosening washer 203 will come into frictional contact with the inner wall of the support plate 102 and the clamping piece 201. Due to factors such as relative motion between components, vibration and impact are inevitably generated. At this time, the anti-loosening washer 203, with its excellent toughness and energy dissipation characteristics, can effectively absorb and disperse vibration and impact energy, preventing loosening at the connection points such as that between the connecting end 105 and the connector 101 caused by excessive vibration and impact, thereby ensuring the reliability of the connection.

Specifically, as shown in FIG. 4, the taper of the outer surface of the conical convex surface 205 is greater than that of the inner surface of the anti-loosening washer 203. When the anti-loosening washer 203 is installed onto the conical convex surface 205, due to the difference in taper between the two, the anti-loosening washer 203 will automatically adjust its position under the guidance of the conical convex surface 205, making its center tend to coincide with the center of the conical convex surface 205, thus achieving automatic centering. This facilitates the installation process. Without the need for additional positioning operations, it can ensure that the anti-loosening washer 203 is accurately installed in the proper position, improving the efficiency and accuracy of the installation.

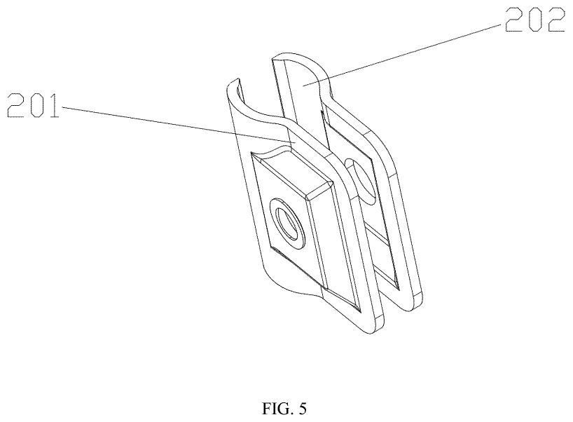

As shown in FIG. 6, a locking mechanism 300 (refer to FIG. 2) is provided on the inner side of the connector 101 to lock the angle adjustment device 100 and the anti-loosening mechanism 200. The locking mechanism 300 includes a first locking member 301 and a second locking member 302. The first locking member 301 passes through the mounting groove 103 (refer to FIG. 3) and sequentially passes through the clamping piece 201, the anti-loosening washer 203, and the conical convex surface 205. At least one end of the first locking member 301 penetrates the connector 101 and forms an extending end 303. The first locking member 301 integrates the various parts of the angle adjustment device 100 and the anti-loosening mechanism 200 into a whole, ensuring the fixed relative positions of the components and effectively preventing loosening or displacement of the components during operation, thereby maintaining the structural stability of the device.

Furthermore, for the specific arrangement of the second locking member 302, please refer to FIG. 4. In this embodiment, the second locking member 302 is located outside the connector 101 and is sleeved on the extending end 303 (see FIG. 6). The second locking member 302 is capable of moving along the extending end 303 towards the connector 101. When the second locking member 302 moves towards the connector 101, the two support plates 102 move closer to each other, and the connecting shaft 104, the clamping piece 201, and the anti-loosening washer 203 are squeezed and locked together, effectively resisting loosening caused by vibration, impact, etc., during the operation of the device. At the same time, due to the difference in taper between the conical convex surface 205 and the anti-loosening washer 203, when the two are engaged, this taper difference generates a radial compressive force between them when subjected to external forces. This compressive force can cause the anti-loosening washer 203 to uniformly contract towards the center, tightly clamping onto the conical convex surface 205. As the external force increases, the radial compressive force also increases, and the friction continuously increases, eventually forming self-locking, effectively preventing loosening of components.

Specifically, referring to FIG. 6, in this embodiment, the first locking member 301 is a bolt, and the second locking member 302 is a locking nut. When the locking nut is screwed, the nut will move along the thread of the bolt in the direction of the connector 101. During this process, the movement of the nut will drive the two support plates 102 to approach each other, thereby achieving the fastening of components such as the angle adjustment device 100, the connecting shaft 104 in the anti-loosening mechanism 200, ensuring the stable initial connection of the holder. The first locking member 301 and the second locking member 302 are not limited to the form of bolts and nuts. In other embodiments, they can also be designed as follows: the first locking member 301 is a long rod, and the second locking member 302 can be sleeved on the extending end 303 and engaged with the extending end 303. By engaging the second locking member 302 at different positions on the extending end 303, the adjustment device can be locked or loosened.

As shown in FIG. 3, in this embodiment, the angle adjustment device 100 pivotally installs the connecting end 105 of the connecting shaft 104 within the mounting groove 103 through the locking mechanism 300 (see FIG. 2). Through the mutual cooperation of the connecting end 105, the mounting groove 103, and the locking mechanism 300, the connecting shaft 104 is firmly installed on the connector 101, thereby connecting to the holder body 1. This connection method ensures that the connecting shaft 104 is stably installed on the holder body 1 while allowing it to rotate to a certain extent, laying the foundation for subsequent angle adjustment functions. In other embodiments, the connecting shaft 104 can also be adjusted in angle at the connecting end 105 by setting gears or universal joint structures to meet different usage needs and scenarios.

Refer to FIG. 8. In this embodiment, the other end of the connecting shaft 104 is equipped with a universal ball 107. Above the connecting shaft 104, there is a clamping mechanism 106. Below the clamping mechanism 106, a pivot groove 108 is recessed. The shape and size of the pivot groove 108 are compatible with the universal ball 107. The connecting shaft 104 and the clamping mechanism 106 can achieve a multi-angle rotational connection through the nested fit of the universal ball 107 and the pivot groove 108. This multi-angle rotational connection allows the clamping mechanism 106 to firmly attach to the connecting shaft 104. Furthermore, through the connection of the connecting shaft 104 with the holder body 1 (refer to FIG. 1), the clamping mechanism 106 and the holder body 1 are tightly connected to form an integrated structure, effectively ensuring the integrity and stability of the entire angle adjustment device 100.

As shown in FIG. 10, in other embodiments of the present disclosure, the support plate 102 in the angle adjustment device 100 can also be replaced with a U-shaped part 401. The U-shaped part 401 is formed by connecting two plates into a single unit, and it is rotationally connected to the holder body 1. The interior of the U-shaped part 401 is configured as a mounting groove 103 (see FIG. 3). The U-shaped part 401, formed by connecting two plates, can reduce manufacturing difficulty, facilitate material selection and diversified design, enhance strength and stability in structural performance, improve assembly precision, and facilitate maintenance and replacement. It can also lower production and transportation costs in terms of cost and economic benefits. In other embodiments, the shape of the U-shaped part 401 can also be replaced with other shapes such as triangular or circular.

Refer to FIG. 10. In this embodiment, a locking mechanism 300 is provided on the U-shaped part 401. The locking mechanism 300 includes a first locking member 301 and a second locking member 302. A rotating handle 402 is provided on the outer surface of the second locking member 302. By operating the rotating handle 402, the second locking member 302 moves along the thread on the first locking member 301 towards the U-shaped part 401, achieving and maintaining a tight connection between the U-shaped part 401 and other components. Meanwhile, the two sides of the U-shaped part 401 gradually approach each other and undergo elastic deformation, generating and maintaining a clamping force on the connected components through elastic recovery force, ensuring the tightness and stability of the connection and preventing loosening.

In summary, as can be seen from the above description, the present disclosure achieves the following technical effects:

The connector 101 in the angle adjustment device 100 can pivot to achieve multi-directional adjustment, and the mounting groove 103 formed by the two support plates 102 can securely install the clamping mechanism 106; the anti-loosening mechanism 200 between the connecting end 105 of the connecting shaft 104 and the connector 101, through the cooperation of the clamping piece 201 and the conical anti-loosening washer 203 with anti-slip patterns 204 and the conical convex surface 205, effectively prevents loosening, absorbs vibration impact energy, and meanwhile the taper difference facilitates automatic centering for easy installation; the locking mechanism 300 integrates various components, and the movement of the nut along the bolt brings the support plates 102 closer to squeeze the components, generating radial clamping force to form self-locking by utilizing the taper difference; the universal ball 107 at the other end of the connecting shaft 104 and the pivot groove 108 of the clamping mechanism 106 are nested to achieve multi-angle rotation; in addition, the U-shaped part 401 replaces the support plate 102 to reduce manufacturing difficulty, enhance structural performance, and save costs.

In the description of the present disclosure, it should be appreciated that directional terms such as “front, rear, up, down, left, right”, “horizontal, vertical, perpendicular, horizontal” and “top, bottom” etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms “inside, outside” refer to the inside and outside relative to the contour of each component itself.

For the convenience of description, spatial relative terms such as “on . . . ”, “above . . . ”, “on the upper surface of . . . ”, “upper” etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as “above other devices or structures” or “on other devices or structures” will subsequently be positioned as “below other devices or structures” or “under other devices or structures”. Thus, the exemplary term “above” can include both “above” and “below” orientations. The device can also be positioned in other different ways (rotated 90 degrees or in other orientations), and the spatial relative descriptions used here should be interpreted accordingly.

In addition, it should be noted that the use of terms such as “first”, “second” etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

What is claimed is:

1. A mobile electronic device holder, comprising a holder body, wherein
the holder body is equipped with an angle adjustment device, the angle adjustment device comprises a connector installed on the holder body, and the connector is provided with a mounting groove; and
the adjustment device further comprises a connecting shaft, one end of which is located in the mounting groove and is configured as a connecting end, and an anti-loosening mechanism is arranged between the connecting end and the connector; and
the anti-loosening mechanism comprises clamping pieces clamped on two radial sides of the connecting end; and
a conical anti-loosening washer is arranged between the clamping pieces and an inner wall of the mounting groove, and a surface of the anti-loosening washer is provided with anti-slip patterns; and
the inner wall of the mounting groove is provided with a conical convex surface, and the anti-loosening washer is sleeved outside the conical convex surface and forms a taper fit with the conical convex surface.

2. The mobile electronic device holder according to claim 1, wherein the connector consists of two parallel support plates, both of which are installed on the holder body and spaced apart from each other, and the space is configured as the mounting groove.

3. The mobile electronic device holder according to claim 2, wherein the connector is provided with a locking mechanism, which is configured to lock the adjustment device and the anti-loosening mechanism.

4. The mobile electronic device holder according to claim 3, wherein the locking mechanism comprises a first locking member and a second locking member, the first locking member passes through the mounting groove and sequentially penetrates the clamping piece, the anti-loosening washer, and the conical convex surface, and at least one end of the first locking member penetrates out of the connector and is configured as an extending end.

5. The mobile electronic device holder according to claim 4, wherein the second locking member is located outside the connector and is sleeved on the extending end, and the second locking member is capable of moving along the extending end towards the connector.

6. The mobile electronic device holder according to claim 5, wherein when the second locking member moves toward the connector, the two support plates approach each other, and the connecting shaft, the clamping pieces, and the anti-loosening washer are squeezed and locked together, while the conical convex surface and the anti-loosening washer form a self-locking through taper fit.

7. The mobile electronic device holder according to claim 6, wherein the first locking member is a bolt, the second locking member is a locking nut, and the locking nut can be rotated to move towards the connector, thereby bringing the two support plates closer to each other.

8. The mobile electronic device holder according to claim 6, wherein the clamping piece is provided with an arc-shaped portion, and the connecting end is clamped between the arc-shaped portions of the clamping pieces on both sides; and
when the anti-loosening mechanism is not locked, the connecting end is rotatable between the arc-shaped portions of the clamping pieces on both sides.

9. The mobile electronic device holder according to claim 1, wherein an outer surface taper of the conical convex surface is greater than an inner surface taper of the anti-loosening washer, and the anti-loosening washer is made of a hard elastic material.

10. A mobile electronic device holder, comprising a holder body, wherein
the holder body is provided with an angle adjustment device, the angle adjustment device comprises a U-shaped part installed on the holder body, and an interior of the U-shaped part is configured as a mounting groove; and
the adjustment device further comprises a connecting shaft, one end of which is located in the mounting groove and is configured as a connecting end, and an anti-loosening mechanism is arranged between the connecting end and a connector; and
the anti-loosening mechanism comprise clamping pieces clamped on two radial sides of the connecting end; and
a conical anti-loosening washer is arranged between the clamping pieces and an inner wall of the mounting groove, and a surface of the anti-loosening washer is provided with anti-slip patterns; and
the inner wall of the mounting groove is provided with a conical convex surface, and the anti-loosening washer is sleeved outside the conical convex surface and forms a taper fit with the conical convex surface; and
the U-shaped part is equipped with a locking mechanism, which is configured to lock the adjustment device and the anti-loosening mechanism.

11. The mobile electronic device holder according to claim 10, wherein the locking mechanism comprises a bolt and a locking nut, the bolt passes through the mounting groove and sequentially penetrates the clamping pieces, the anti-loosening washer, and the conical convex surface.

12. The mobile electronic device holder according to claim 11, wherein both ends of the bolt penetrate through the U-shaped part, with one end abutting against an outer surface of the U-shaped part, and the other end extending outward and configured as an extending end.

13. The mobile electronic device holder according to claim 12, wherein the locking nut is located outside the U-shaped part and is sleeved on the extending end, and is threadedly connected with the extending end.

14. The mobile electronic device holder according to claim 13, wherein the locking nut can be rotated to move towards the U-shaped part, and the two sides of the U-shaped part move closer to each other and undergo elastic deformation.

15. The mobile electronic device holder according to claim 14, wherein when the two sides of the U-shaped part move closer to each other, the connecting shaft, the clamping pieces, and the anti-loosening washer are squeezed and locked together, and the conical convex surface and the anti-loosening washer form a self-locking through taper fit.

16. The mobile electronic device holder according to claim 11, wherein an outer surface of the locking nut is provided with a rotating handle.

17. The mobile electronic device holder according to claim 10, wherein one end of the connecting shaft located outside the U-shaped frame is equipped with a clamping mechanism for clamping a mobile electronic device.
